(19) United States
(12) Patent Application Publication
(10) Pub. No.: US 2016/0041459 A1
(43) Pub. Date: Feb. 11, 2016

(54) Projector

(71) Applicant: SEIKO EPSON CORPORATION, Tokyo (JP)

(72) Inventors: Makoto OTANI, Matsumoto-shi (JP); Akitaka YAJIMA, Tatsuno-Machi (JP)

(73) Assignee: SEIKO EPSON CORPORATION, Tokyo (JP)

(21) Appl. No.: 14/815,126

(22) Filed: Jul. 31, 2015

(30) Foreign Application Priority Data
Aug. 6, 2014 (JP) 2014-160186

(51) Int. Cl. G03B 21/20

(52) U.S. Cl. CPC G03B 21/2053

(57) ABSTRACT

A relay system (formed of a plurality of optical systems) that generates a spherical aberration allows each light ray flux to be so adjusted that the cross section thereof has a moderate size (moderate degree of spread) on an image panel surface of each color modulation light valve, that is, the light ray flux is not brought into complete focus but is blurred. Further, as the aberrations to be generated, the amount of spherical aberration is set to be much greater than those of the other third-order aberrations, whereby generated spots are allowed to have the same shape irrespective of the field position.

### BACKGROUND

1. Technical Field

The present invention relates to a projector including a first spatial modulation device and a second spatial modulation device arranged in series along an optical path.

2. Related Art

There is a known projector in which two spatial modulation devices are arranged in series for an increase in contrast of an image (see JP-A-2007-218946, for example). In this case, a relay lens is disposed between the two spatial modulation devices to superimpose an image of one of the two spatial modulation devices on the other spatial modulation device.

In JP-A-2007-218946, in which two or more spatial modulation devices are arranged in series and a relay system achieves a substantial subject-image relationship between the two spatial modulation devices (the term “subject-image relationship” used herein means that one is imaged on the other and vice versa) to improve the contrast of an image, the relay system does not cause the position of an image of one of the spatial modulation devices to completely coincide with the position of the other spatial modulation device. That is, the two spatial modulation devices are so arranged that the substantially subject-image relationship is achieved, but the image is defocused so that the position of an image of one of the spatial modulation devices does not completely coincide with the position of the other spatial modulation device. The defocus configuration prevents generation of a moire pattern due to pixels or inter-pixel black matrices in the spatial modulation devices.

In JP-A-2007-218946, however, the arrangement of the spatial modulation devices that achieves the defocused state is advantageous in preventing formation of images of dust and other objects in an image and generation of a moire pattern, but there is still an in-focus position along the optical path even in the defocused state. For example, in a state in which the surface of a substrate of a panel that forms one of the spatial modulation devices is brought into focus, dust or any other object present on the surface of the substrate is undesirably captured in an image even in the defocused state.

### SUMMARY

An advantage of some aspects of the invention is to provide a projector of a type in which two spatial modulation devices are arranged in series and an aberration is used between the two spatial modulation devices to reduce the visibility of the boundary between a bright portion and a dark portion in the image plane of a projected image for formation of a high-quality image with generation of a moire pattern suppressed.

A projector according to an aspect of the invention includes an illumination system that outputs light, a light modulator that modulates the light outputted from the illumination system, and a projection system that projects the light modulated by the light modulator. The light modulator includes a first pixel matrix and a second pixel matrix arranged in series along an optical path of the light outputted from the illumination system and a relay system disposed on the optical path between the first pixel matrix and the second pixel matrix, and the relay system generates a greater amount of spherical aberration than the amounts of other third-order aberrations (Seidel aberrations). The phrase “the two pixel matrices are arranged in series along the optical path” means that along the single optical path, one of the pixel matrices (first pixel matrix, for example) is disposed in a position upstream of the other pixel matrix (second pixel matrix, for example) along the optical path. That is, the phrase means that the first and second pixel matrices are arranged in relatively upstream and downstream positions along the optical path.

According to the projector described above, the relay system disposed on the optical path between the first pixel matrix and the second pixel matrix generates aberrations instead of providing a defocused state to achieve a state in which an image is blurred even in a position where the image is supposed to be brought into best focus along the optical path, whereby generation of a moire pattern can be suppressed, and a situation in which dust and other objects on a substrate surface are captured in a projected image can be avoided. In general, the degree of a blur based on generation of an aberration varies depending, for example, on the field position, resulting in a uniform blur, which possibly affects image formation. In contrast, in the aspect of the invention, generating a spherical aberration, which is an aberration that is roughly uniform across the linage plane irrespective of the field position, by a greater amount than the other aberrations allows a desired degree of blur to be obtained and the state of a blurred image to be maintained in a satisfactory manner.

In a specific aspect of the invention, the amount of a third-order aberration of the spherical aberration is at least three times greater than the amounts of the other third-order aberrations in the relay system. In this case, the degree of effect of the spherical aberration can be sufficiently greater than the effects of the other aberrations, whereby a desired spot shape can be formed irrespective of the field position.

In another aspect of the invention, the following relationship is satisfied:

0.5 ML≦r≦3 ML

where L is the intervals between pixels in the first pixel matrix, M is the magnification factor of the relay system, and r is a minimum spot radius among spot radii obtained when an image plane of the relay system is moved along the optical axis. In this case, generation of a moire pattern resulting from a black matrix can be sufficiently suppressed. Further, for example, the degree of halo that accompanies the blur at the time of image projection can be suppressed to a point where it is not substantially visible.

In still another aspect of the invention, the relay system is an equal magnification optical system that is symmetric along the optical path. In this case, when the relay system is configured to be symmetric with reference, for example, to the position of an aperture, the two pixel matrices can be formed based on the same standard, such as the size and thickness, and disposed in the same manner, whereby coma and distortion can be suppressed.

In still another aspect of the invention, the relay system has a double Gauss lens. In this case, the double Gauss lens can moderately suppress aberrations.

In still another aspect of the invention, the relay system has a pair of meniscus lenses each having positive power and so disposed that the meniscus lenses sandwich the double Gauss lens along the optical path. In this case, when the pair of meniscus lenses are so disposed that they are convex toward the double Gauss lens, aberrations can be further corrected, and the telecentricity can be improved.

In still another aspect of the invention, each of the first and second pixel matrices is a transmissive liquid crystal pixel matrix. In this case, a simple structure allows formation of a bright image. Further, the pair of meniscus lenses can be located in positions close to the first and second pixel matrices, whereby the aberration correction function of the meniscus lenses can be improved.

In still another aspect of the invention, the projector further includes a color separation/light guiding system that separates the light outputted from the illumination system into a plurality of color light fluxes having difference wavelength bands, a modulation system that has a plurality of light modulators provided in correspondence with the plurality of color light fluxes and each having the first and second pixel matrices and the relay system and modulates the plurality of color light fluxes separated by the color separation/light guiding system, and a light combining system that combines the color modulated light fluxes modulated by the modulation system and outputs the combined light toward the projection system. In this case, a color image that is a combination of a plurality of modulated color light fluxes can be formed.

In still another aspect of the invention, in the light modulator, out of the first and second pixel matrices, one pixel of the first pixel matrix disposed on the upstream side along the optical path corresponds to a plurality of pixels of the second pixel matrix disposed on the downstream side along the optical path. In this case, in the first pixel matrix, the luminance can be adjusted on an area basis (area corresponds to a plurality of pixels in the second pixel matrix), and the luminance can be adjusted on a pixel basis in the second pixel matrix.

### BRIEF DESCRIPTION OF THE DRAWINGS

The invention will be described with reference to the accompanying drawings, wherein like numbers reference like elements.

FIG. 1 shows a schematic configuration of a projector according to a first embodiment or Example 1.

FIG. 2 is a development of an optical path from a first pixel matrix to a second pixel matrix in the projector shown in FIG. 1.

FIG. 3 shows focused light fluxes on an image panel surface.

FIG. 4 describes a spot shape affected by a spherical aberration.

FIGS. 5A and 5B show aberrations in the vicinity of a position where an image of the second pixel matrix is formed in Example 1.

FIG. 6 shows changes in spot shape in Example 1.

FIGS. 7A and 7B describe focus positions in Comparative Example.

### DESCRIPTION OF EXEMPLARY EMBODIMENTS

### First Embodiment

A projector according to a first embodiment of the invention will be described below in detail with reference to the drawings.

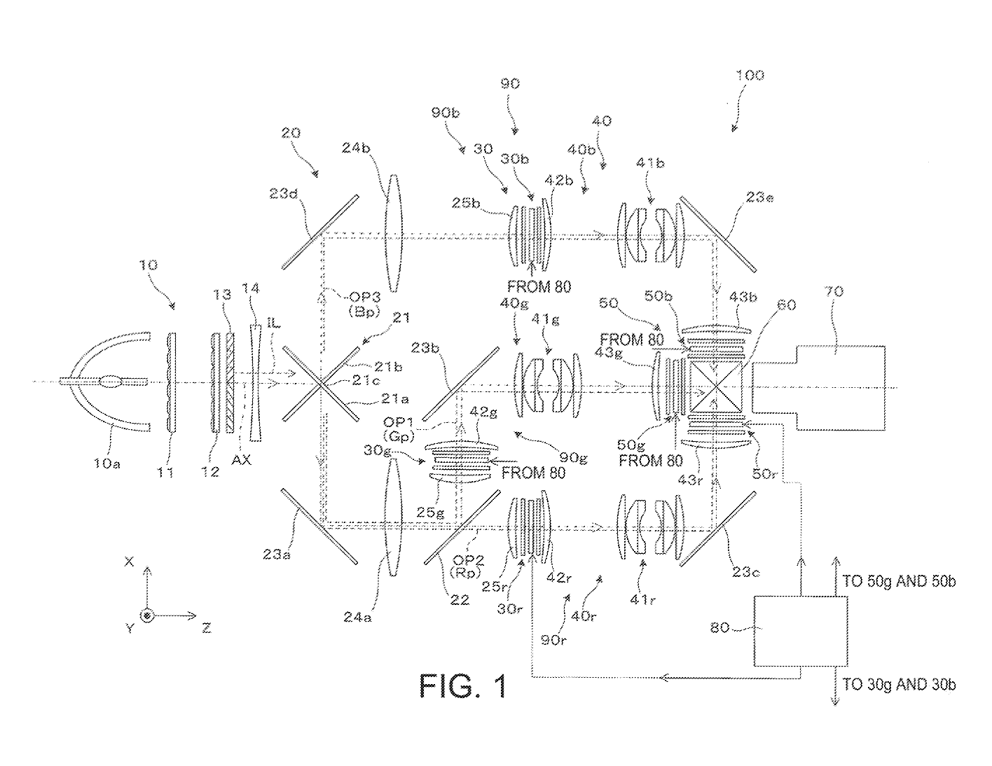

A projector 100 according to the first embodiment of the invention includes an illumination system 10, which outputs illumination light, a color separation/light guiding system 20, which separates the illumination light into color light fluxes and guides them, a modulation system 90, which spatially modulates the color light fluxes separated from the light outputted from the illumination system 10 by the color separation/light guiding system 20, a light combining system 60, which combines the separated, modulated color light fluxes (modulated light fluxes), a projection system 70, which projects the combined light, and a projector controller 80, as shown in FIG. 1. Among them, in particular, the modulation system 90 includes a light control system 30, which includes first pixel matrices, a relay system 40, which is responsible for relay of light from the first pixel matrices to second pixel matrices, and an image display system 50, which includes the second pixel matrices. The projector controller 80 controls the action of each of the optical systems. In the following description, the optical axis of the entire optical system of the projector 100 is called an optical axis AX. In FIG. 1, it is assumed that a plane containing the optical axis AX is parallel to the XZ plane, and that the direction of the axis along which image light exits is called a +Z direction.

The illumination system 10 includes a light source 10a, a first lens array (first optical integration lens) 11 having a plurality of lens elements arranged in an array, a second lens array (second optical integration lens) 12, a polarization conversion element 13, which converts light from the second lens array 12 into predetermined linearly polarized light, and a superimposing lens 14, and the illumination, system 10 outputs illumination light having sufficient intensity necessary for image formation. The light source 10a is, for example, an ultrahigh-pressure mercury lamp and emits light containing R light, G light, and B light. The light source 10a may instead be a discharge light source other than an ultrahigh-pressure mercury lamp or may be an LED, a laser, or any other solid-state light source. The lens arrays 11 and 12 divide a light ray flux from the light source 10a into a plurality of light ray fluxes and collect them, and the polarization conversion element 13 cooperates with the superimposing lens 14 and condenser lenses 24a, 24b, 25g, 25r, and 25b, which will be described later, to form illumination light fluxes to be superimposed on one another on illuminated regions of light control light valves that form the light control system 30.

The color separation/light guiding system 20 includes a cross dichroic mirror 21, a dichroic mirror 22, deflection mirrors 23a, 23b, 23c, 23d, and 23e, first lenses (condenser lenses) 24a and 24b, second lenses (condenser lenses) 25g, 25r, and 25b. The cross dichroic mirror 21 includes a first dichroic mirror 21a and a second dichroic mirror 21b. The first and second dichroic mirrors 21a, 21b are set perpendicular to each other, and an intersection axis 21c, where the two dichroic mirrors intersect each other, extends in the Y direction. The color separation/light guiding system 20 separates the illumination light from the illumination system 10 into three color light fluxes or green, red, and blue light fluxes and guides the color light fluxes.

The modulation system 90 is formed of a plurality of light modulators corresponding to the separated three color light fluxes. In the present embodiment, in particular, the modulation system 90 includes the light control system 30, which is located in a relatively upstream position on the optical path, the image display system 50, which is located in a relatively downstream position on the optical path, and the relay system 40, which is disposed between the light control system 30 and the image display system 50.

Among the optical systems in the modulation system 90, the light control system 30 includes non-self-luminous light control light valves 30g, 30r, and 30b, which adjust the intensities of the three color light fluxes corresponding to the three colors (red, green, and blue) separated by the color separation/light guiding system 20. Each of the light control light valves 30g, 30r, and 30b includes the first pixel matrix. Specifically, each of the light control light valves 30g, 30r, and 30b includes a transmissive liquid crystal pixel matrix (liquid crystal panel) that is a main body of the first pixel matrix, a light-incident-side polarizer provided on the light-incident side of the first pixel matrix, and a light-exiting-side polarizer provided on the light-exiting side of the first pixel matrix. The light-incident-side polarizer and the light-exiting-side polarizer are disposed in a cross-nicol arrangement. Control action of the light control light valves 30g, 30r, and 30b will be briefly described below. A brightness control signal is first determined based on an image signal inputted from the projector controller 80. A light control driver that is not shown is then controlled by the determined brightness control signal. The thus controlled light control driver drives the light control light valves 30g, 30r, and 30b to adjust the intensities of the three color (red, green, and blue) light fluxes.

Among the optical systems in the modulation system 90, the relay system 40 is formed of three optical systems 40g, 40r, and 40b in correspondence with the three light control light valves 30g, 30r, and 30b, which form the light control system 30. For example, the optical system 40g includes a double Gauss lens 41g and a pair of meniscus lenses 42g and 43g. The pair of meniscus lenses 42g and 43g are each a positive meniscus lens and so arranged along the optical path that they sandwich the double Gauss lens 41g, and the meniscus lenses 42g and 43g are so disposed that they are convex toward the double Gauss lens 41g. That is, the convex surface of each of the meniscus lenses 42g and 43g faces the double Gauss lens 41g. The other optical systems 40r and 40b also include double Gauss lenses 41r and 41b, each of which has the same structure as that of the double Gauss lens 41g, and pairs of meniscus lenses 42r/43r and 42b/43b.

Among the optical systems in the modulation system 90, the image display system 50 includes non-self-luminous color modulation light valves 50g, 50r, and 50b, which modulate the intensity spatial distributions of the color light fluxes that are three incident illumination light fluxes corresponding to the three color (red, green, and blue) light fluxes having passed through the relay system 40. Each of the color modulation light valves 50g, 50r, and 50b includes the second pixel matrix, which is a transmissive liquid crystal pixel matrix. Specifically, each of the color modulation light valves 50g, 50r, and 50b includes a liquid crystal pixel matrix (liquid crystal panel) that is the second pixel matrix, a light-incident-side polarizer provided on the light-incident side of the second pixel matrix, and a light-exiting-side polarizer provided on the light-exiting side of the second pixel matrix. Control action of each of the color modulation light valves 50g, 50r, and 50b will be briefly described below. The projector controller 80 first converts an inputted image signal into an image light valve control signal. The converted image light valve control signal then controls a panel driver that is not shown. The three color modulation light valves 50g, 50r, and 50b driven by the controlled panel driver modulate the three color light fluxes to form images according to the inputted image information (image signal).

The modulation system 90 described above can also be considered as an optical system formed of three light modulators 90g, 90r, and 90b. That is, the light modulator 90g is arranged in correspondence with the green light and includes the light control light valve 30g, the optical system 40g, and the color modulation light valve 50g. Similarly, the light modulator 90r is arranged in correspondence with the red light and includes the light control light value 30r, the optical system 40r, and the color modulation light valve 50r. The light modulator 90b is arranged in correspondence with the blue light and includes the light control light valve 30b, the optical system 40b, and the color modulation light valve 50b. When the modulation system 90 is taken as the three light modulators 90g, 90r, and 90b as described above, one of the light modulators (light modulator 90g, for example) is formed of the light control light valve having the first pixel matrix (light control light valve 30g), the relay system (optical system 40g), and the color modulation light valve having the second pixel matrix (color modulation light valve 50g) arranged in this order along the optical path. That is, the light control light valve and the color modulation light valve that correspond to each other are arranged in series.

The light combining system 60 is a cross dichroic prism formed of four rectangular prisms bonded to each other. The light combining system 60 combines the color modulated light fluxes modulated by the color modulation light valves 50g, 50r, and 50b, which form the image display system 50, with one another and outputs the combined light toward the projection system 70.

The projection system 70 projects the combined light from the light combining system 60, which has combined the light fluxes modulated by the color modulation light valves 50g, 50r, and 50b, which are the light modulators, with one another, toward a subject (not shown), such as a screen.

Formation of the image light will be described below in detail. The illumination system 10 first outputs an illumination light ray flux IL as the illumination light. In the color separation/light guiding system 20, the first dinars in mirror 21a of the cross dichroic mirror 21 then reflects the green (G) light and the red (R) light contained in the illumination light ray flux IL and transmits the remaining blue (B) light. On the other hand, the second dichroic mirror 21b of the cross dichroic mirror 21 reflects the blue (B) light and transmits the green (G) light and the red (R) light. The dichroic mirror 22 receives the green and red (GR) light fluxes incident thereon, reflects the green (G) light, and transmits the remaining red (R) light. A more detailed description will now be made of color light fluxes Gp, Rp, and Bp, which are separated from the illumination light ray flux IL by the color separation/light guiding system 20, along optical paths OP1 to OP3 for the respective colors. The illumination light ray flux IL from the illumination system 10 is first incident on and separated by the cross dichroic mirror 21. Among the components of the illumination light ray flux IL, the green light Gp (optical path OP1) is reflected off the first dichroic mirror 21a of the cross dichroic mirror 21 and branches off the illumination light ray flux IL, travels via the deflection mirror 23a, is further reflected off the dichroic mirror 22 and hence branches off the green/red light, and is incident on the light control light valve 30g, which corresponds to the green light Gp, among the three light control light valves of the light control system 30. Among the components of the illumination light ray flux IL, the red light Rp (optical path OP2) is reflected off the first dichroic mirror 21a of the cross dichroic mirror 21 and branches off the illumination light ray flux IL, travels via the deflection mirror 23a, passes through the dichroic mirror 22 and hence branches off the green/red light, and is incident on the light control light valve 30r, which corresponds to the red light Rp, among the three light control light valves of the light control system 30. Among the components of the illumination light ray flux IL, the blue light Bp (optical path OP3) is reflected off the second dichroic mirror 21b of the cross dichroic mirror 21 and branches off the illumination light ray flux IL, travels via the deflection mirror 23d, and is incident on the light control light valve 30b, which corresponds to the blue light Bp, among the three light control light valves of the light control system 30. The light control light valves 30g, 30r, and 30b, which form the light control system 30, adjust the intensities of the three color (red, green, and blue) light fluxes Gp, Rp, and Bp under the control of the projector controller 80, as described above. The first lenses 24a and 24b and the second lenses 25g, 25r, and 25b, which are disposed on the optical paths OP1 to OP3, are provided to adjust the angles of the color light fluxes Gp, Rp, and Bp incident on the corresponding light control light valves 30g, 30r, and 30b.

The color light fluxes Gp, Rp, and Bp having passed through the light control system 30, where the luminance values thereof are adjusted, pass through the optical systems 40g, 40r, and 40b, which are disposed in correspondence with the respective colors and form the relay system 40, and enter the three color modulation light valves 50g, 50r, and 50b, which form the image display system 50. That is, the green light Gp outputted from the light control light valve 30g travels via the optical system 40g and the deflection mirror 23b and enters the color modulation light valve 50g. The red light Rp outputted from the light control light valve 30r travels via the optical system 40r and the deflection mirror 23c and enters the color modulation light valve 50r. The blue light Bp outputted from the light control light valve 30b travels via the optical system 40b and the deflection mirror 23e and enters the color modulation light valve 50b. The color modulation light valves 50g, 50r, and 50b, which form the image display system 50, modulate the three color light fluxes to form images of the respective colors under the control of the projector controller 80, as described above. The color modulated light fluxes modulated by the color modulation light valves 50g, 50r, and 50b are combined with one another in the light combining system 60, and the combined light is projected by the projection system 70.

In the case described above, the lengths of the optical paths OP1 to OP3 for the respective colors are equal to one another, that is, the optical paths OP1 to OP3 have an equidistance optical length.

In the projector 100 described, above, each of the first pixel matrix and the corresponding second pixel matrix (pixel matrix of light control light valve 30g and pixel matrix of color modulation light valve 50g, for example) need to have the substantially subject-image relationship. Depending on the state in which the first matrix is imaged on the second matrix, however, a moire pattern is likely to be generated due, for example, to boundaries that form the pixel matrices (black matrices, for example). In the present embodiment, in the configuration described above, the relay system 40 is configured to generate aberrations, in particular, generate a larger amount of spherical aberration than the amounts of the other aberrations. The present embodiment can thus provide a high-quality image.

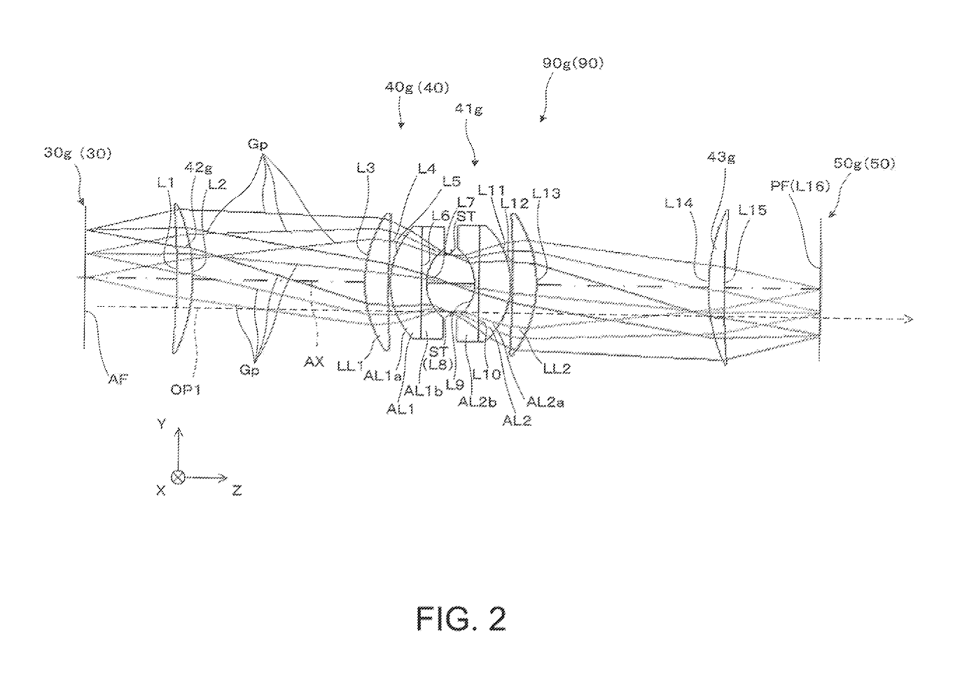

FIG. 2 is a development of an example of the optical path from one of the first pixel matrix to the corresponding second pixel matrix (optical path OP1, for example). In FIG. 2, each of the XYZ directions is shown provided that the light traveling direction in the developed state is the +Z direction. FIG. 2 shows a state in which the illumination light is focused along one of the three optical paths (optical path OP1, for example) divided in the color separation process, specifically, shows a state in which illumination light (green light Gp) is focused in the light modulator (light modulator 90g in the case of optical path OP1), which is the modulation system 90 and formed of the light control system 30 (light control light valve 30g), the relay system 40 (optical system 40g), and the image display system 50 (color modulation light valve 50g), particularly, the optical system 40g, which forms the relay system 40. The developments of the other optical paths (optical paths OP2 and OP3, for example) are the same as the development of the optical path OP1 and will not therefore be illustrated or described.

The optical system 40g includes the double Gauss lens 41g and the pair of meniscus lenses 42g and 43g, as described above. Each of the portions that form the optical system 40g will be specifically described with reference to FIG. 2. First, the double Gauss lens 41g is formed of a first lens LL1, a first achromat lens AL1, an aperture ST, a second achromat lens AL2, and a second lens LL2 sequentially arranged along the optical path. Each of the first achromat lens AL1 and the second achromat lens AL2 is a combination of two lenses. That is, the first achromat lens AL1 is formed of a lens AL1a and a lens AL1b bonded to each other, and the second achromat lens AL2 is formed of a lens AL2a and a lens AL2b bonded to each other. Each of the first achromat lens AL1 and the second achromat lens AL2 therefore has the following lens surfaces: a front surface; a rear surface; and a bonding surface, three in total.

The pair of meniscus lenses 42g and 43g are each a lens having positive refractive power, have the same shape, are symmetrically arranged with reference to the double Gauss lens 41g in such a way that they sandwich the double Gauss lens 41g, and are particularly so arranged that they are convex toward the double Gauss lens 41g. That is, the meniscus lens 42g, which is a first meniscus lens disposed behind the light control light valve 30a, is convex toward the downstream side along the optical path, and the meniscus lens 43g, which is a second meniscus lens disposed in front of the color modulation light valve 50g, is convex toward the upstream side along the optical path. In the present embodiment, the optical system 40g is a symmetric, equal magnification (1×) optical system.

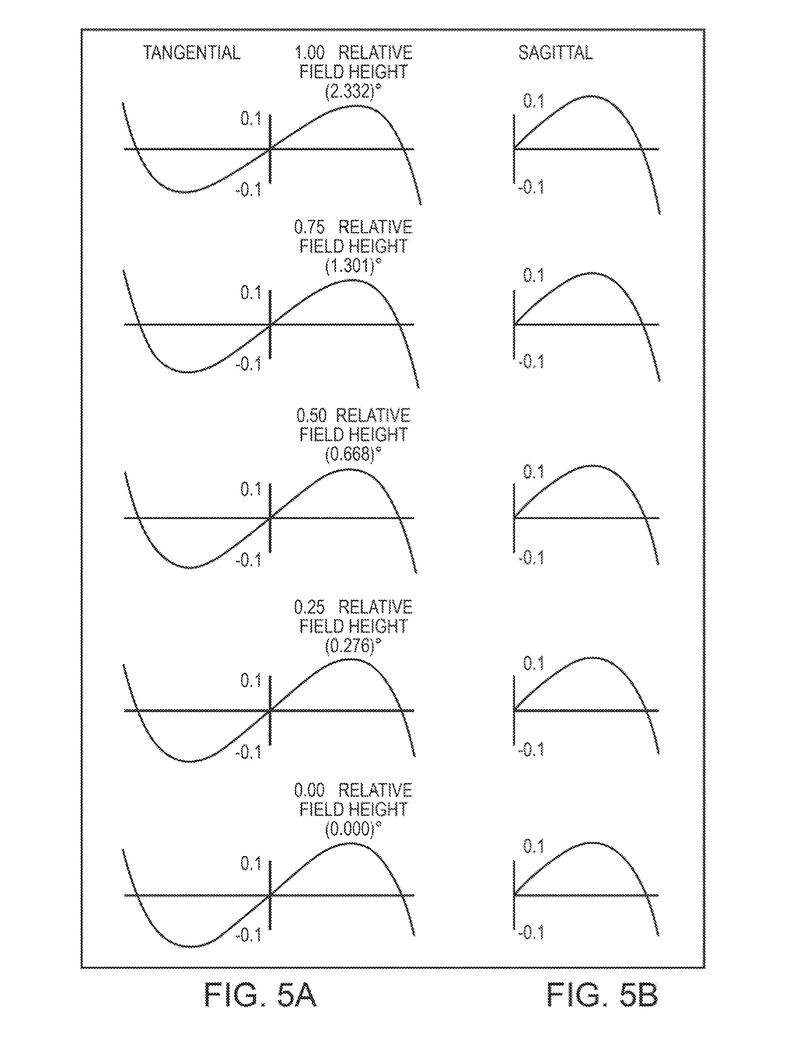

In the optical system 40g, the meniscus lens 42g, the first lens LL1, and the first achromat lens AL1, which are disposed on the upstream side of the aperture ST along the optical path, have a lens surface L1 and a lens surface L2, a lens surface L3 and a lens surface L4, and a lens surface L5, a lens surface L6, and a lens surface L7, respectively. The position of the aperture ST is called an aperture plane L8. Further, in the optical system 40g, the second achromat lens AL2, the second lens LL2, and the meniscus lens 43g, which are disposed on the downstream side of the aperture ST along the optical path, have a lens surface L9, a lens surface L10, and a lens surface L11, a lens surface L12 and a lens surface L13, and a lens surface L14 and a lens surface L15, respectively. The position of an image panel surface PF, which is an irradiated surface of the color modulation light valve 50g, is also called a panel surface L16. An optical system that forms the relay system 40, such as the optical system 40g, generates a larger amount of spherical aberration than the other aberrations, and a specific example of the generated aberrations will be described later with reference to FIGS. 5A and 5B and other figures.

In the present embodiment, the optical system 40g, which forms the relay system 40 described above, is configured to generate aberrations, particularly a spherical aberration by a much greater amount than the other aberrations. In general, known third-order aberrations excluding the spherical aberration include the following aberrations called coma; distortion; field curvature; and astigmatism (five third-order aberrations). When these aberrations are generated, defocusing and image distortion occur, and it is typically important to minimize the amounts of theses aberrations for improvement in optical performance. In contrast, in the present embodiment, aberrations are used to generate a blur in an image formation position or in the vicinity thereof for suppression of generation of a moire pattern. The third-order aberrations described above, however, generate different blurs (degrees of blur). In particular, the state of a blurred image changes depending on a field position in some cases. For example, coma and astigmatism generate blurred images having different spot shapes depending on the field position, undesirably resulting in non-uniform light ray fluxes. In contrast, the spherical aberration generates blurred, images having a fixed spot shape irrespective of the field position. In view of the fact described above, in the present embodiment, the relay system 40 (optical system 40g) is configured to generate only the spherical aberration or positively generate only the spherical aberration while suppressing the other aberrations to achieve blurring (generate a blur) based on the thus generated spherical aberration, whereby the amount of the difference in the degree of blurring depending on the field position is suppressed and generation of a moire pattern is suppressed at the same time.

The item described above holds true also for the other optical systems 40r and 40b (see FIG. 1), which form the relay system 40.

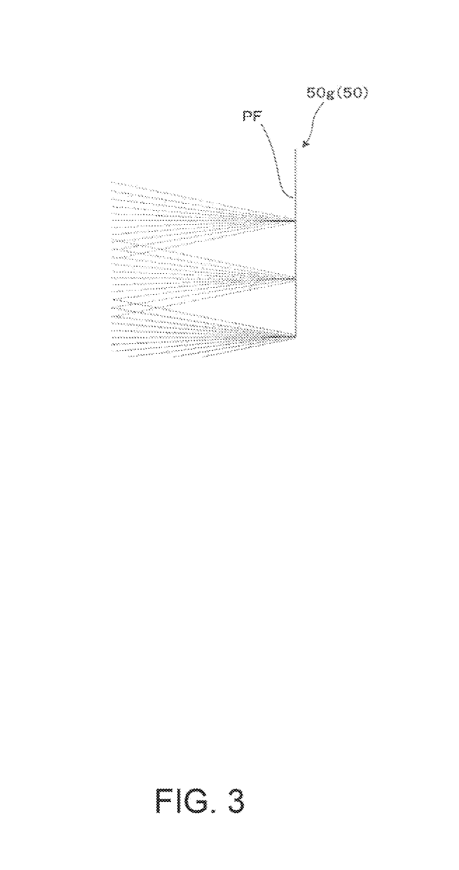

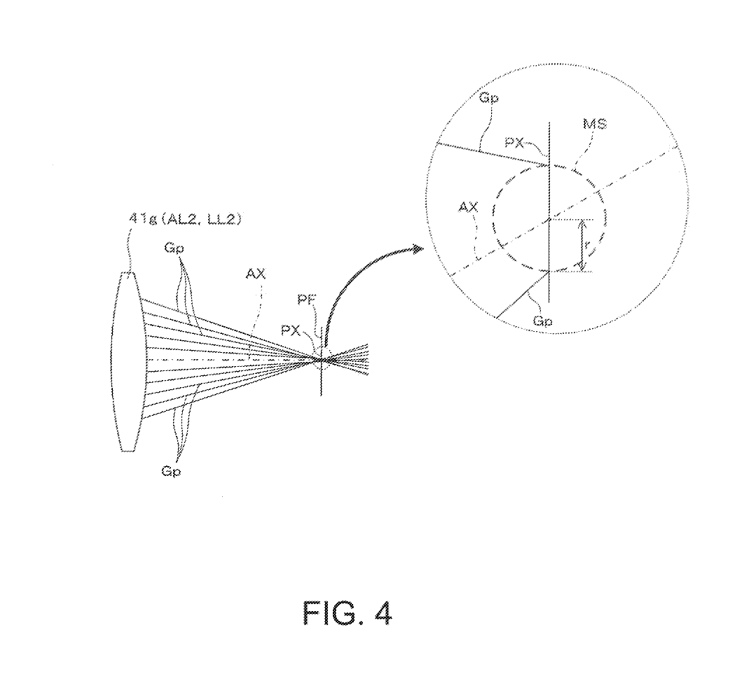

FIG. 3 is an enlarged view of an image formation plane of the optical system 40g, which forms the relay system 40. FIG. 3 shows that each light flux is not focused into a single point but residual aberrations are still present. Therefore, even when the first pixel matrix, which forms the light control light valve 30g, and the second pixel matrix, which forms the color modulation light valve 50g, are so located that they are brought into best focus with respect to each other, the formed image is blurred, whereby generation of a moire pattern can be suppressed. Further, as a result of the aberrations generated by the optical system 40g, even on the image panel surface PF of the color modulation light valve 50g, where the illumination light (color light Gp) is brought into best focus, or a portion in the vicinity of the image panel surface PF, the color light Gp is not brought into complete focus, as illustrated in FIG. 4. As described above, since the light control light valve 30g and the color modulation light valve 50g are not allowed to have the subject-image relationship, dust having adhered, for example, to the surface of the light control light valve 30g is not captured in a projected image.

A light ray flux focused on the image panel surface PF of the color modulation light valve 50g will be specifically described in terms of the cross-sectional shape (spot shape) of the light ray flux. The generation of the aberrations described above prevents the light outputted from the light control light valve 30g from being sharply focused on the optical axis AX or the image panel surface PF and in a reference position PX, which is a position in the vicinity of the optical axis AX, but causes the light to form a spot shape MS (light ray flux cross-sectional shape) having a finite size to some extent on an image plane even when the light is supposed to be brought into best focus on the image panel surface PF, as shown, for example, in an enlarged inset in FIG. 4. Further, in this case, the aberrations generated by the optical system 40g prevent the light from being brought into focus in any position other than those along the image panel surface PF. Therefore, in observation of the image plane of the light ray flux in any position from the light control light valve 30g to the color modulation light valve 50g, the spot shape having a finite size to some extent (non-spot--like shape) is observed as described above, and the size is minimized in a position where the light ray flux is brought into best focus.

In the description, the circular spot shape MS on the image panel surface PF is assumed to be a minimum spot shape and has a minimum spot radius, as shown in FIG. 4. In the present embodiment, let L be the intervals between the pixels in the light control light valve 30g, which has the first pixel matrix, M be the magnification factor of the optical system 40g, which forms the relay system 40, and r be the minimum spot radius among the spot radii obtained when the image plane of the optical system 40g is moved along the optical axis, and the following relationship is satisfied.

0.5 ML≦r≦3 ML (1)

When the relay system 40 (optical system 40g) is an equal magnification optical system, that is, 1× optical system, Expression (1) described above is rewritten as follows.

0.5 L≦r≦3 L (1′)

When the minimum spot radius z is the lower limit of Expression (1′) described above, that is, r=0.5 L, a light ray flux outputted from the light control light valve 30g and having a width corresponding to one pixel, that is, equal to the intervals L between the pixels on a light control panel surface AF (see FIG. 2), which is the light exiting surface of the light control light valve 30g, impinges and spreads on the image panel surface PF outward from the original width by 0.5 L. Setting the minimum spot radius r at a value greater than or equal to the lower limit allows the light ray flux to be moderately mixed with another light ray flux, whereby the generation of a moire pattern resulting from black matrices on the light control panel surface AF can be suppressed.

When the minimum spot radius r is the upper limit of Expression (1′) described above, that is, r=3 L, a light ray flux output ted from the light control light valve 30a and having a width corresponding to one pixel, that is, equal to the intervals L between the pixels on the light control panel surface AF impinges and spreads on the image panel surface PF outward from the original width by 3 L, Setting the minimum spot radius r at a value smaller than or equal to the upper limit prevents the light ray flux from mixing with another light ray flux more than moderately, whereby an increase, for example, in visibility of halo at the time of image projection can be suppressed.

The above description has been made with reference to the case where the relay system 40 is an equal magnification optical system, that is, has a magnification factor M=1. The same consideration holds true for a case where M is a general value including values other than 1 (the case where Expression (1) described above is satisfied), and no description will therefore be made of the case.

The aberrations generated by the optical system 40g, which forms the relay system 40, will be described with reference to FIGS. 5A and 5B, which show data on the aberrations as an example, and other figures.

FIGS. 5A and 5B show lateral aberrations generated by the relay lens. Specifically, FIG. 5A is a lateral aberration diagram in the Y direction assuming that light travels in the Z direction, as in FIG. 2, and FIG. 5B is a Lateral aberration diagram in the X direction. FIGS. 5A and 5B show lateral aberrations associated with a light ray having a wavelength of 550 nm by way of example among light rays in a variety of wavelength bands. The graphs in FIGS. 5A and 5B represent the aberrations in field positions of 0 mm, 3 mm, 6 mm, 9 mm, and 12 mm from the lowermost to uppermost graphs. As seen from the aberration diagrams of FIGS. 5A and 5B, roughly the same amount of aberration is generated over the entire range of the field position.

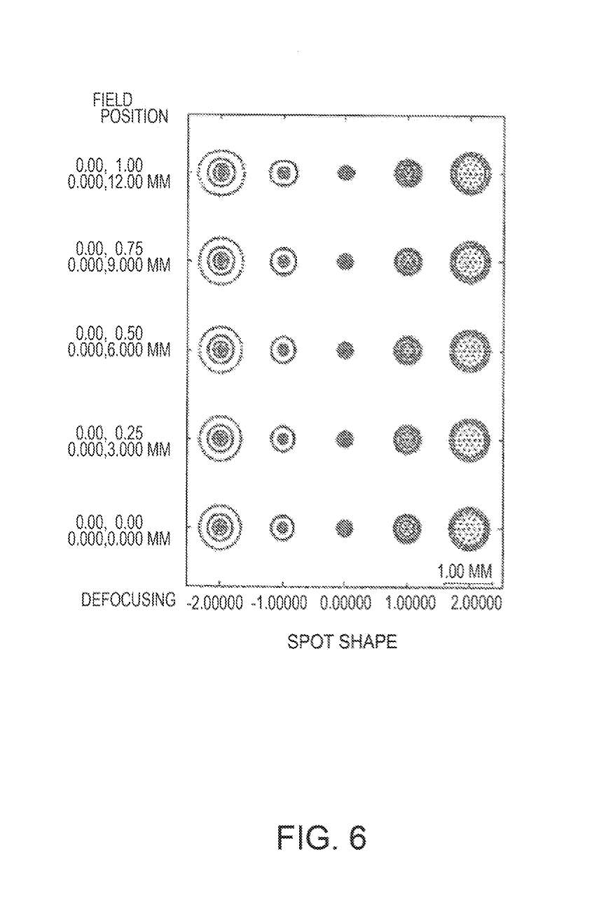

FIG. 6 shows spot shapes generated when the defocus position and the field position are changed. In FIG. 6, the horizontal axis represents the defocus position, and the vertical axis represents the field position. The vertical and horizontal axes are expressed in units of millimeters. The spot shapes at the center (third position) along the horizontal axis correspond to the reference position FX in FIG. 4. The markings along the vertical axis represent field positions of 0 mm, 3 mm, 6 mm, 9 mm, and 12 mm from the lowermost to uppermost markings. As seen from FIG. 6, the size of the spot shape remains fixed also in the position where the size of the spot is minimized. FIG. 6 also shows that the spot shape remains the same irrespective of the field position.

As described above, in the projector 100 according to the present embodiment, since the relay system (such as optical system 40g) generates a spherical aberration, which is one of the aberrations, each light ray flux is so adjusted that the cross section thereof has a moderate size (moderate degree of spread) on the image panel surface PF of each of the color modulation light valves 50g, 50r, and 50b, that is, the light ray flux is not brought into complete focus but is blurred. As a result, a high-quality image can be formed with generation of a moire pattern suppressed. Further, as the aberrations to be generated, the amount of spherical aberration is intentionally set to be much greater than those of the other third-order aberrations, in other words, generation of the aberrations other than the spherical aberration is suppressed, whereby generated spots are allowed to have the same shape irrespective of the field position.

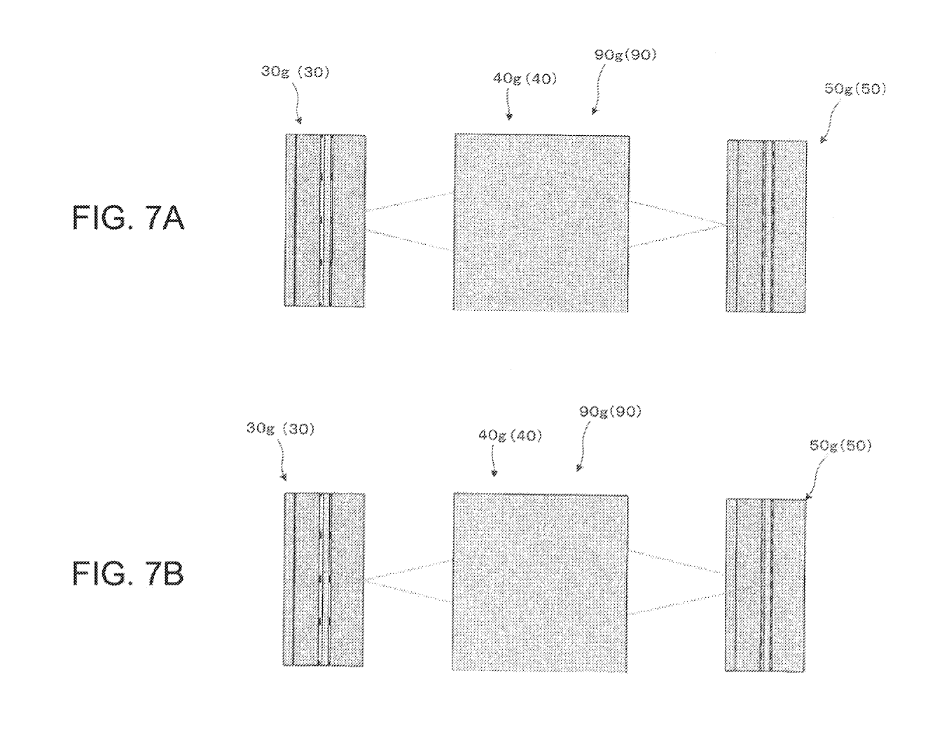

Further, in the projector 100 according to the present embodiment, the generated spherical aberration prevents the light control light valve 30g and the color modulation light valve 50g, which are conjugate with each other, from having the subject-image relationship. That is, as in Comparative Example shown in FIGS. 7A and 7B, for example, in an optical system in which no (little amount of) aberration is generated, it is conceivable, for example, to use defocusing to generate a blur. In this case, there is a position brought into focus on the image panel surface of the color modulation light valve 50g. FIG. 7A shows an example of a case where the image panel surface is irradiated with light with an image of the light control light valve 30g defocused and hence blurred. FIG. 7B shows the same case as that shown in FIG. 7A but the light control panel surface is irradiated with light with an image of the color modulation light valve 50g defocused and hence blurred. In this case, the light control light valve 30g and the color modulation light valve 50g are not brought into focus with respect to each other. A light ray viewed from the side where the color modulation light valve 50g is present, however, is brought into focus on the surface of the light control light valve 30g, as shown, for example, in FIG. 7B. Therefore, when dust or any other object adheres to the surface of the light control light valve 30g, the dust is undesirably captured in an image. In the projector 100 according to the present embodiment, in which the relay system 40 generates a spherical aberration, the undesirable situation does not occur.

In the example described above, the resolution of the light control light valves 30g, 30r, and 30b, which form the light control system 30, is lower than the resolution of the color modulation light valves 50g, 50r, and 50b, which form the image display system 50. Even when the resolution of the light control light valves 30g, 30r, and 30b differs from the resolution of the color modulation light valves 50g, 50r, and 50b, the adjustment that a moderate blur is generated as described above allows a portion corresponding to the boundary between a bright portion and a dark portion on the side where luminance adjustment is made to be less visible when an image is projected. The resolution is not necessarily set as described above, and the resolution of the color modulation light valves 50g, 50r, and 50b may, for example, be equal to the resolution of the light control light valves 30g, 30r, and 30b.

### EXAMPLES

Examples of the relay system in the projector according to the embodiment of the invention will be described below. Reference characters used in Examples are summarized as follows.
R: Radius of curvature of a lens surface
D: Distance between lenses
Nd: Refractive index of an optical, material at d line
Vd: Abbe number of an optical material at d line

### Example 1

Table 1, which is presented below, shows data on the optical surfaces that forma relay system in Example 1. FIGS. 1 and 2 show the lenses in Example 1. In the upper field in Table 1, “surface number” represents numbers assigned to lens surfaces and other planes sequentially from the object side. That is, the surface numbers correspond to surfaces L1 to L16 shown in FIG. 2. Further, as a specific aspect of the projector including the relay system, it is, for example, conceivable that the pixel interval L is 100 μm, the relay system is an equal magnification optical system (M=1), and the value F of the f-number of the relay system is F=2.5.

TABLE 1

| Surface | Radius of | Inter-surface | | |
|---|---|---|---|---|
| number | curvature (R) | distance (D) | Nd | νd |
| Object (AF) | ∞ | 23 | | |
| 1 | −200 | 4 | 1.84666 | 23.8 |
| 2 | −46.3 | 44 | | |
| 3 | 31.54 | 6 | 1.80440 | 39.6 |
| 4 | 311.4 | 0.5 | | |
| 5 | 20.36 | 8 | 1.79952 | 42.2 |
| 6 | ∞ | 1.2 | 1.76182 | 26.5 |
| 7 | 11.02 | 6.16 | | |
| 8 (aperture) | ∞ | 6.16 | | |
| 9 | −11.02 | 1.2 | 1.76182 | 26.5 |
| 10 | ∞ | 8 | 1.79952 | 42.2 |
| 11 | −20.36 | 0.5 | | |
| 12 | −311.4 | 6 | 1.80440 | 39.6 |
| 13 | −31.54 | 44 | | |
| 14 | 46.3 | 4 | 1.84666 | 23.8 |
| 15 | 200 | 23 | | |
| 16 (PF) | ∞ | 2 | | |

The aberrations generated by the relay system (optical system 40g) and the spot diagram produced by the relay system (optical system 40g) in the present example are those shown in FIGS. 5A, 5B, and 6.

In addition to the above, it is conceivable to employ a configuration in which the value F of the f-number is F=5 (Example 2). Table 2 shows comparison between aberration values in Examples described above and those in Comparative Examples with the aberration values being numeral values of the third-order aberrations, in particular, comparison in terms of the third-order aberration of the spherical aberration and the other third-order aberrations. Specifically, the upper fields show numerical values of the third-order aberrations of the following aberrations: spherical aberration (SA) ; coma (TCO); field curvature (TAS); astigmatism (SAS); and distortion (DST), and the lower fields show the ratios of the spherical aberration (SA) to the other aberrations. The last column of the ratio fields describes the minimum (Min) of the four ratios. As shown in Table 2, the spherical aberration is greater than the other aberrations both in Examples 1 and 2. Specifically, in Table 2, Comparative Examples 1 to 9 include a case where the spherical aberration is not much greater than the other four third-order aberrations, whereas Examples 1 and 2 show that the spherical aberration is at least 3 times greater than any of the other four third-order aberrations. In particular, in Example 1, the spherical aberration is at least 4 times greater than the other four third-order aberrations. Providing a large difference among the aberrations and setting the spherical aberration to be a primary aberration (the other aberrations are suppressed as compared with the spherical aberration) allows the spot shapes to be uniformly blurred across an image (see FIG. 6) irrespective of the field position.

TABLE 2

| | Lens type | | | | |
|---|---|---|---|---|---|
| | | | TAS | | |
| | | TCO | Tangen- | SAS | |
| | SA | Tangen- | tial | Sagittal | DST |
| | Spherical | tial | image | image | Distor- |
| | aberration | coma | plane | plane | tion |
| Example 1 | −0.42 | 0.00 | −0.09 | 0.03 | 0.00 |
| (F = 2.5) | | | | | |
| Example 2 | −0.24 | 0.00 | −0.08 | 0.02 | 0.00 |
| (F = 5) | | | | | |
| Comparative | −0.21 | −0.46 | −1.08 | −0.39 | 1.47 |
| example 1 | | | | | |
| Comparative | −0.24 | −0.15 | −0.89 | −0.33 | 0.86 |
| example 2 | | | | | |
| Comparative | −0.23 | 0.00 | −0.98 | −0.36 | 0.50 |
| example 3 | | | | | |
| Comparative | −0.02 | 0.00 | −0.01 | −0.02 | 0.00 |
| example 4 | | | | | |
| Comparative | −0.01 | 0.00 | −0.01 | −0.02 | 0.00 |
| example 5 | | | | | |
| Comparative | −0.02 | 0.00 | −0.03 | −0.04 | 0.00 |
| example 6 | | | | | |
| Comparative | −0.01 | −0.10 | 0.07 | −0.02 | −0.15 |
| example 7 | | | | | |
| Comparative | 0.03 | −0.11 | 0.08 | −0.02 | −0.15 |
| example 8 | | | | | |
| Comparative | 0.06 | −0.12 | 0.07 | −0.02 | −0.15 |
| example 9 | | | | | |

| | Lens type | | | | |
|---|---|---|---|---|---|
| | Ratio | | | | |
| | SA/TCO | SA/TAS | SA/SAS | SA/DST | Min |
| Example 1 | 1924.5 | 4.5 | 15.8 | 121.9 | 4.5 |
| (F = 2.5) | | | | | |
| Example 2 | 1595.5 | 3.1 | 10.9 | 69.2 | 3.1 |
| (F = 5) | | | | | |
| Comparative | 0.5 | 0.2 | 0.5 | 0.1 | 0.1 |
| example 1 | | | | | |
| Comparative | 1.6 | 0.3 | 0.7 | 0.3 | 0.3 |
| example 2 | | | | | |
| Comparative | 60.8 | 0.2 | 0.6 | 0.5 | 0.2 |
| example 3 | | | | | |
| Comparative | 1471.6 | 1.8 | 0.9 | 35.8 | 0.9 |
| example 4 | | | | | |
| Comparative | 381.4 | 1.2 | 0.4 | 12.9 | 0.4 |
| example 5 | | | | | |
| Comparative | 655.8 | 0.9 | 0.6 | 15.2 | 0.6 |
| example 6 | | | | | |
| Comparative | 0.1 | 0.2 | 0.5 | 0.1 | 0.1 |
| example 7 | | | | | |
| Comparative | 0.2 | 0.4 | 1.4 | 0.2 | 0.2 |
| example 8 | | | | | |
| Comparative | 0.5 | 0.8 | 3.1 | 0.4 | 0.4 |
| example 9 | | | | | |

### Others

The invention is not limited to the embodiment described above and can be implemented in a variety of aspects to the extent that they do not depart from the substance of the invention.

Each of the light control light valves 30g, 30r, and 30b and the color modulation light valves 50g, 50r, and 50b is a transmissive light valve in the above description. Instead, liquid crystal panels based on a TN method, a VA method, and an IPS method, and liquid crystal panels of a variety of other types can be used. Further, a transmissive light valve is not necessarily used, and a reflective light valve can be used. The term “transmissive” used herein means that the liquid crystal panel transmits modulated light, and the term “reflective” used herein means that the liquid crystal panel reflects modulated light.

In the above description, the three light control light valves 30g, 30r, and 30b, which form the light control system 30, and the three color modulation light valves 50g, 50r, and 50b, which form the image display system 50, are provided, and the six light valves in total are used, but other configurations can be employed. For example, one light control light valve can be disposed as the light control system 30 in a stage upstream of the color separation/light guiding system 20. Instead, one light control light valve can be disposed as the light control system 30 in a stage downstream of the light combing system 60.

In the above description, the relay system includes a double Gauss lens and a pair of meniscus lenses each having positive power, but the configuration described above is not essential, and a configuration having no meniscus lens and a configuration having no double Gauss lens or no meniscus lens can be employed.

In the above description, color images formed by the plurality of color modulation light valves 50g, 50r, and 50b are combined with one another. The plurality of color modulation light valves, that is, color modulation devices can be replaced with a color or monochromatic color modulation light valve that is a single light modulation device (color modulation device), and an image formed by the single color modulation light valve can be enlarged and projected by the projection system 70. In this case, the light control light valves can be replaced with a single light modulation device (luminance modulation deice), which can be disposed in a stage upstream or downstream of the color modulation light valve.

In the above description, the optical paths for the divided color light fluxes are equal in optical length to one another. A configuration in which the optical paths are not equal in optical length to one another in length can instead be employed.

Each of the color modulation light valves 50g, 50r, and 50b can be replaced, for example, with a digital micromirror device leaving micromirrors that serve as pixels and used as the light modulation device.

In the above description, the position where the spot radius is minimized coincides with the position of the image panel surface PF of the color modulation light valve 50g, but the configuration described above is not necessarily employed. For example, the position where the spot radius is minimized may be slightly shifted from the position of the image panel surface PF along the optical axis.

The entire disclosure of Japanese Patent Application No. 2014-160186, filed Aug. 6, 2014 is expressly incorporated by reference herein.

What is claimed is:

1. A projector comprising:
an illumination system, chat outputs light;
a light modulator that modulates the light output ted from the illumination system; and
a projection system that projects the light modulated by the light modulator,
wherein the light modulator includes a first pixel matrix and a second pixel matrix arranged in series along an optical path of the light outputted from the illumination system and a relay system disposed on the optical path between the first pixel matrix and the second pixel matrix, and
the relay system generates a greater amount of spherical aberration than the amounts of other third-order aberrations.

2. The projector according to claim 1,
wherein the amount of a third-order aberration of the spherical aberration is at least three times greater than the amounts of the other third-order aberrations in the relay system.

3. The projector according to claim 1,
wherein the following relationship is satisfied:
05. ML≦r≦3 ML
where L is the intervals between pixels in the first pixel matrix, M is the magnification factor of the relay system, and r is a minimum spot radius among spot radii obtained when an image plane of the relay system is moved along the optical axis.

4. The projector according to claim 1,
wherein the relay system is an equal magnification optical system that is symmetric along the optical path.

5. The projector according to claim 1,
wherein the relay system has a double Gauss lens.

6. The projector according to claim 5,
wherein the relay system has a pair of meniscus lenses each having positive power and so disposed that the meniscus lenses sandwich the double Gauss lens along the optical path.

7. The projector according to claim 1,
wherein each of the first and second pixel matrices is a transmissive liquid crystal pixel matrix.

8. The projector according to claim 1, further comprising:
a color separation/light guiding system that separates the light outputted from the illumination system into a plurality of color light fluxes having difference wavelength hands;
a modulation system that has a plurality of light modulators provided in correspondence with the plurality of color light fluxes and each having the first and second pixel matrices and the relay system and modulates the plurality of color light fluxes separated by the color separation/light guiding system; and
a light combining system that combines the color modulated light fluxes modulated by the modulation system and outputs the combined light toward the projection system.

9. The projector according to claim 1,
wherein in the light modulator, out of the first and second pixel matrices, one pixel of the first pixel matrix disposed on the upstream side along the optical path corresponds to a plurality of pixels of the second pixel matrix disposed on the downstream side along the optical path.
